(19) United States
(12) Patent Application Publication
(10) Pub. No.: US 2022/0116561 A1
(43) Pub. Date: Apr. 14, 2022

(54) ACTIVE FOCUSING NON-LINE-OF-SIGHT METHODS AND SYSTEMS

(71) Applicant: California Institute of Technology, Pasadena, CA (US)

(72) Inventors: Jian Xu, Redmond, WA (US); Ruizhi Cao, Pasadena, CA (US); Changhuei Yang, South Pasadena, CA (US)

(21) Appl. No.: 17/450,633

(22) Filed: Oct. 12, 2021

Related U.S. Application Data
(60) Provisional application No. 63/090,429, filed on Oct. 12, 2020.

(51) Int. Cl. H04N 5/369; G01S 17/89; G01S 7/481

(52) U.S. Cl. CPC H04N 5/36961; G01S 17/931; G01S 7/4817; G01S 17/89

(57) ABSTRACT

Active focusing non-line-of-sight methods and systems for focusing light over or around an obstacle to an object where light is focused using wavefront shaping based on feedback readings of light scattered by a two-dimensional scatterer such as a wall.

### CROSS-REFERENCES TO RELATED APPLICATIONS

This application claims priority to and benefit of U.S. Provisional Patent Application No. 63/090,429, titled “FOCUSING LIGHT AROUND/OVER AN OBSTACLE” and filed on Oct. 12, 2020, which is hereby incorporated by reference in its entirety and for all purposes.

### FIELD

Certain embodiments pertain generally to non-line-of-sight (NLOS) imaging, and more particularly, to active focusing non-line-of-sight (AFN) imaging and detection that can be implemented in, for example, autonomous vehicle applications.

### BACKGROUND

Some techniques for NLOS imaging of an object obscured by an obstacle focus on using time-of-flight measurements and computational trajectory back-tracing to infer the profile of the object. Examples of these NLOS imaging techniques based on speckle correlations can be found in Bertolotti, J. et al., “Non-invasive imaging through opaque scattering layers,” Nature 491, pp. 232-234, (2012) and Katz, O., Heidmann, P., Fink, M. & Gigan, S., “Non-invasive single-shot imaging through scattering layers and around corners via speckle correlations,” Nature Photonics 8, pp. 784-790 (2014), which are hereby incorporated by reference in their entirety. Examples of NLOS imaging techniques using time-of-flight measurements can be found in Velten, A., Willwacher, T. Gupta, O., Veeraraghavan, A. Bawendi, M. G. and Raskar, R., “Recovering three-dimensional shape around a corner using ultrafast time-of-flight imaging,” Nat. Commun., 3, 745 (2012), O'Toole, M., Lindell, D. B., and Wetzstein, G., “Confocal non-line-of-sight imaging based on the light-cone transform,” Nature 555, 338-341 (2018), Xin, S. et al., “A Theory of Fermat Paths for Non-Line-Of-Sight Shape Reconstruction,” IEEE/CVF Conference on Computer Vision and Pattern Recognition (CVPR), pp. 6793-6802 (2019), Kadambi, A., Zhao, H., Shi, B., and Raskar, R., “Occluded Imaging with Time-of-Flight Sensors,” ACM Trans Graph 35, 15:1-15:12 (2016), Buttafava, M., Zeman, J., Tosi, A., Eliceiri, K., and Velten, A., “Non-line-of-sight imaging using a time-gated single photon avalanche diode,” Opt. Express 23, 20997-21011 (2015),” and Gupta, O., Willwacher, T., Velten, A., Veeraraghavan, A., and Raskar, R., “Reconstruction of hidden 3D shapes using diffuse reflections,” Opt. Express 20, 19096-19108 (2012), which are hereby incorporated by reference in their entirety. Examples of NLOS imaging techniques based on phase field and other computational imaging methods can be found in Gupta, M., Nayar, S. K., Hullin, M. B. & Martin, J. “Phasor Imaging: A Generalization of Correlation-Based Time-of-Flight Imaging. ACM Transactions on Graphics 34, 156:1-156:18 (2015), Liu, X., et al., “Non-line-of-sight imaging using phasor-field virtual wave optics,” Nature 572, 620-623 (2019), Reza, S. A., et al. “Phasor field waves: A Huygens-like light transport model for non-line-of-sight imaging applications,” Optics Express 27, 29380-29400 (2019), and Saunders, C., Murray-Bruce, J. & Goyal, V. K., “Computational periscopy with an ordinary digital camera,” Nature 565, 472 (2019), which are hereby incorporated by reference in their entirety.

### SUMMARY

Certain aspects pertain to active focusing non-line-of-sight (AFN) methods. In one aspect, the AFN methods include focusing light over or around an obstacle to an object, the light focused using wavefront shaping based on readings of light scattered by a two-dimensional scatterer.

Certain aspects pertain to AFN methods for focusing light over or around an obstacle to an object that include determining a global (spatial light modulator) phase pattern for a full aperture projected to the two-dimensional scatterer and determining phase offsets between adjacent sub-apertures of the full aperture. In one aspect, (I) the global phase pattern is determined by determining a phase pattern for each sub-aperture that maximizes readings of light scattered by the two-dimensional scatterer and/or (II) the phase offsets are determined by determining a phase offset for adjacent sub-apertures of each sub-aperture pair of a plurality of sub-aperture pairs of the full aperture that maximizes readings of light scattered by the two-dimensional scatterer.

Certain aspects pertain to AFN methods that focuses light over or around an obstacle to an object, the light focused using wavefront shaping based on readings of light scattered by a two-dimensional scatterer. The focused light configured to deliver focused energy for localized excitation and/or heating to the object.

Certain aspects pertain to an AFN method that focuses light over or around an obstacle to an object, the light focused using wavefront shaping based on readings of light scattered by a two-dimensional scatterer. The method also includes imaging the object by scanning a focal spot across a vicinity of the object, the focal spot based on the wavefront shaping.

Certain aspects pertain to an AFN method that focuses light over or around an obstacle to an object, the light focused using wavefront shaping based on readings of light scattered by a two-dimensional scatterer. The method also includes generating a focal spot using a global phase pattern and phase offsets determined at least in part by: (I) iteratively determining a phase pattern for each sub-aperture projected to the two-dimensional scatterer that maximizes readings of light scattered by the two-dimensional scatterer; and/or (II) iteratively determining a relative phase offset between adjacent sub-apertures of each sub-aperture pair of a plurality of sub-aperture pairs that maximizes readings of light scattered by the two-dimensional scatterer.

Certain aspects pertain to non-transitory computer readable medium for active focusing non-line-of-sight imaging, when read by one or more processors, operatively coupled to a light detector and a spatial light modulator, cause the one or more processors to execute one or more operations comprising focusing light over or around an obstacle to an object, the light focused using wavefront shaping based on light detector readings of light scattered by a two-dimensional scatterer.

Certain aspects pertain to AFN systems for focusing light over or around an obstacle to an object. In one aspect, an AFN system for focusing light over or around an obstacle to an object comprises a spatial light modulator configured to generate one or more phase patterns. The system also includes one or more optical elements configured to image light transmitted through, or reflected from, the spatial light modulator to a two-dimensional scatterer, wherein light reflected from the two-dimensional scatterer illuminates at least a portion of an object. The system also includes a light detector configured generate readings based at least in part on light scattered by the two-dimensional scatterer. The spatial light modulator is configured to modulate phase based on a global phase pattern and phase offsets between the sub-aperture pairs to generate a focal spot on the object, wherein the global phase pattern and phase offsets are determined to maximize readings from the light detector.

These and other features are described in more detail below with reference to the associated drawings.

### BRIEF DESCRIPTION OF THE DRAWINGS

FIG. 1A is a schematic diagram of components of an AFN system during an optimization procedure of an AFN method, according to an implementation.

FIG. 1B is a schematic diagram of the AFN system in FIG. 1A during a scanning procedure of the AFN method, according to an implementation.

FIG. 2 is a block diagram of components of an AFN system for focusing light around/over an obstacle to an object, according to an implementation.

FIG. 3 is a schematic diagram of components of an AFN system during operation, according to an implementation.

FIG. 4 is a schematic diagram depicting steps of an example of an AFN method, according to an implementation.

FIG. 5 is a flowchart depicting an example of an AFN method, according to an implementation.

FIG. 6 illustrates a flowchart depicting an example of sub-operations of an operation of the AFN method depicted in FIG. 5, according to an implementation.

FIG. 7 is a flowchart depicting an example of sub-operations of an operation of the AFN method depicted in FIG. 6, according to an implementation.

FIG. 8 is a flowchart depicting an example of sub-operations of an operation of the AFN method depicted in FIG. 5, according to an implementation.

### DETAILED DESCRIPTION

Different aspects are described below with reference to the accompanying drawings. The features illustrated in the drawings may not be to scale. In the following description, numerous specific details are set forth in order to provide a thorough understanding of the presented embodiments. The disclosed embodiments may be practiced without one or more of these specific details. In other instances, well-known operations have not been described in detail to avoid unnecessarily obscuring the disclosed embodiments. While the disclosed embodiments will be described in conjunction with the specific embodiments, it will be understood that it is not intended to limit the disclosed embodiments. Moreover, although many disclosed embodiments of active focusing non-line-of-sight (AFN) methods and systems will be described for imaging or detecting as may be used in autonomous vehicle applications, it would be understood that these embodiments are not so limited. The AFN methods and systems can also have applications in other areas such as, for example, delivery of focused energy at high optical intensities for local excitation or heating (e.g., ablation) purposes.

### I. Introduction

Certain aspects pertain to active focusing non-line-of-sight (AFN) methods and systems that can actively focus light around/over an obstacle and onto an object by controlling the reflection of light off a two-dimensional scatterer (e.g., a wall). The reflection of light may be controlled using wavefront shaping that characterizes the phase shift of light scattered by the two-dimensional scatterer. These AFN techniques can directly counteract the optical distortion created from the scattering by tailoring the phase front of the optical field. In some cases, the tightly focused light spot formed by these AFN techniques may be near the diffraction limit and/or may be smaller than the object itself. In an imaging implementation, the obstructed object can be actively imaged by scanning the focal spot over the object. This imaging implementation may be used to address certain limitations in sensing and sensors that may be used in, for example, autonomous vehicle applications.

Certain AFN techniques may be used to increase image resolution, depth range, and dynamic range of imaging obstructed object, and opens up the opportunity to perform high power spectroscopy on distant objects. Although many examples are described with respect to imaging implementations, AFN techniques may also be used, for example, to deliver focused energy at high optical intensities to the obstructed object for local excitation or heating purposes. For example, the focused light can be used to ablate or transfer focused optical power at high orders of magnitude to an object (or objects).

### A. Examples of Wavefront Shaping Techniques

Some examples of wavefront shaping techniques can be found in Yaqoob, Z, Psaltis, D., Feld, M. S., and Yang, C., “Optical phase conjugation for turbidity suppression in biological samples,” Nat. Photonics 2, 110-115 (2008), Mosk, A. P., Lagendijk, A., Lerosey, G., and Fink, M., Controlling waves in space and time for imaging and focusing in complex media,” Nat. Photonics 6, 283-292 (2012), Xu, X., Liu, H., and. Wang, L. V, “Time-reversed ultrasonically encoded optical focusing into scattering media,” Nat. Photonics 5, 154-157 (2011), Wang, Y. M., Judkewitz, B., DiMarzio, C. A. and Yang, C., “Deep-tissue focal fluorescence imaging with digitally time-reversed ultrasound-encoded light,” Nat. Commun. 3, 928 (2012), Judkewitz, B., Wang, Y. M. Horstmeyer, R., Mathy, A., and Yang, C., “Speckle-scale focusing in the diffusive regime with time reversal of variance-encoded light (TROVE),” Nat. Photonics 7, 300-305 (2013), Ma, C., Xu, X., Liu, Y., and Wang, L. V., “Time-reversed adapted-perturbation (TRAP) optical focusing onto dynamic objects inside scattering media,” Nat. Photonics 8, 931-936 (2014), Horstmeyer, R., Ruan, H., and Yang, C., “Guidestar-assisted wavefront-shaping methods for focusing light into biological tissue,” Nat. Photonics 9, 563-571 (2015), Ruan, H., Haber, T., Liu, Y., Brake, J., Kim, J., Berlin, J. M., and Yang, C., “Focusing light inside scattering media with magnetic-particle-guided wavefront shaping,” Optica 4, 1337-1343 (2017), Vellekoop, I. M., Feedback-based wavefront shaping,” Opt. Express 23, 12189-12206 (2015), Lai, P., Wang, L., Tay, J. W., and Wang, L. V., “Photoacoustically guided wavefront shaping for enhanced optical focusing in scattering media,” Nat. Photonics 9, 126-132 (2015), Katz, O., Small, E., Bromberg, Y., and Silberberg, Y., “Focusing and compression of ultrashort pulses through scattering media,” Nat. Photonics 5, 372-377 (2011), Nixon, M., et al., “Real-time wavefront shaping through scattering media by all-optical feedback,” Nat. Photonics 7, 919-924 (2013), Vellekoop I. M., and Mosk, A. P., “Focusing coherent light through opaque strongly scattering media,” Opt. Lett. 32, 2309-2311 (2007), Popoff, S. M., et al., “Measuring the Transmission Matrix in Optics: An Approach to the Study and Control of Light Propagation in Disordered Media,” Phys. Rev. Lett. 104, 100601 (2010), Popoff, S., et al., “Image transmission through an opaque material,” Nat. Commun. 1, 81 (2010), Mounaix, M., et al., “Spatiotemporal Coherent Control of Light through a Multiple Scattering Medium with the Multispectral Transmission Matrix,” Phys. Rev. Lett. 116, 253901 (2016), and Stern G., and Katz, O., “Noninvasive focusing through scattering layers using speckle correlations, Opt. Lett. 44, 143-146 (2019), which are hereby incorporated by reference in their entireties. Some of these examples of wavefront shaping use a guidestar. Some examples of wavefront shaping using the optical memory effect can be found in Stern G., and Katz, O., “Noninvasive focusing through scattering layers using speckle correlations,” Opt. Lett. 44, 143-146 (2019), Bertolotti, J., van Putten, E. G., Blum, C., Lagendijk, A., Vos, W. L., and Mosk, A. P., “Non-invasive imaging through opaque scattering layers,” Nature 491, 232-234 (2012), Katz, O., Heidmann, P., Fink, M. and Gigan, S., “Non-invasive single-shot imaging through scattering layers and around corners via speckle correlations,” Nat. Photonics 8, 784-790 (2014), Wu, T., Katz, O., Shao, X., and Gigan, S., “Single-shot diffraction-limited imaging through scattering layers via bispectrum analysis,” Opt. Lett. 41, 5003-5006 (2016), and Cua, M., (Haojiang) Zhou, E., and Yang, C., “Imaging moving targets through scattering media,” Opt. Express 25, 3935-3945 (2017), which are hereby incorporated by reference in their entireties.

### II. Active Focusing Non-Line-of-Sight (AFN) Systems

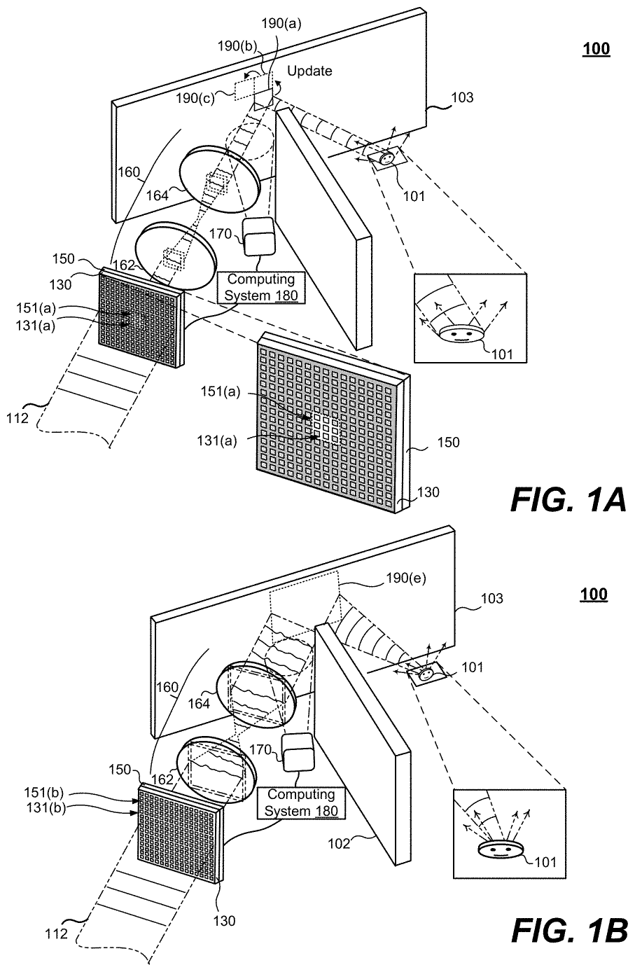

FIG. 1A is a simplified schematic diagram of components of an AFN system 100 during an optimization procedure of an AFN method, according to an implementation. FIG. 1B is a schematic diagram of the AFN system 100 in FIG. 1A during an optional scanning procedure of the AFN method, according to an implementation.

In FIGS. 1A and 1B, AFN system 100 includes a spatial light modulator (SLM) 130, an adjustable pupil 150, a 4f optical system 160 including a first lens 162 and a second lens 164, a light detector 170, and a computing device 180. The SLM 130 is in optical communication with adjustable pupil 150 and adjustable pupil 150 is in optical communication with the 4f optical system 160. AFN system 100 is optically configured with the 4f optical system 160 such that the SLM 130 and adjustable pupil 150 and a two-dimensional scatterer 103 are an image-forming conjugate plane set. In this way, a scaled version of the phase pattern displayed on the SLM 130 will be projected onto two-dimensional scatterer 103. During operation, plane wave illumination 112 from a light source such as a laser (e.g., a continuous wave laser or a pulsed laser) passes to SLM 130. The light source may be a component of AFN system 100 or a separate component.

In FIG. 1A, the SLM 130 is shown modulating a phase pattern 131(a) and the adjustable pupil 150 (e.g., a digital micromirror device (DMD)) has open a first sub-aperture 151(a) for optimization. In this example, plane wave illumination 112 passes to SLM 130 and SLM 130 modulates the light according to phase pattern 131(a). Light transmitted through SLM phase pattern 131(a) and onto the adjustable pupil 150 with open sub-aperture 151(a) is projected onto an area 190(a) on the two-dimensional scatterer 103. A scaled version of the SLM pattern 131(a) is projected onto two-dimensional scatterer 103 in area 190(a) through the implementation of 4f optical system 160. Light reflected from the two-dimensional scatterer 103 will project a speckle field at the plane of object 101. The speckle field may have a size nominally given by λd/a, where a is the lateral size of the sub-aperture, λ is the wavelength of light, and d is the distance between the two-dimensional scatterer and the object. For example, if the distance between a two-dimensional scatterer and an object is 10 m and the object size is 10 mm and the wavelength of light is 500 nm, the sub-aperture size can be set to about 500 μm for a speckle size that is similar to the size of the object.

In FIG. 1A, the reflected light from the object 101 will scatter off two-dimensional scatterer 103 (the second bounce for the involved photons) and be sampled by the light detector 170. During one implementation of an optimization procedure, phase relationships between the sub-apertures are determined that maximize the scattered feedback signal from the light detector 170. The phase relationships may then be applied to focus an optimally bright speckle spot on the object 101 to create an optical focus on the object 101 as depicted in FIG. 1B. By adjusting the phase relationships between the subsets of pixels of the sub-apertures to maximize the scattered feedback signal from the light detector 170 in this optimization procedure, an optimally bright speckle at the object can be generated to create an optical focus on the object.

In certain implementations, the optimization procedure includes an operation for optimizing the phase patterns and an operation for optimizing the relative phase offsets between sub-aperture pairs to determine an optimized global phase pattern used to render the final focal spot. In FIG. 1A, AFN system 100 is shown during an operation of an optimization procedure where phase (mask) patterns for a plurality of sub-apertures of the full aperture are being optimized by iterating through each of the sub-apertures of a full-aperture. At the instant shown in FIG. 1A, a sub-aperture 190(a) is being optimized. As depicted, the optimization operation iterates through the sub-apertures by updating the adjustable pupil 150 to open another sub-aperture 190(b), updating the adjustable pupil 150 to open another sub-aperture 190(c), and so on until the plurality of sub-apertures of the full aperture have been optimized. Once the optical focus at the object 101 for the subset of SLM pixels of sub-aperture 190(a) is complete, the optimization operation turns on a different subset of pixels 190(b), and so forth. The process is repeated until all subsets of pixels (all sub-apertures) of the full aperture have been optimized. The number of sub-apertures, [symbol] , used in the optimization procedure depends on the desired focal resolution. The number of sub-apertures, [symbol] , will in aggregate to form a full aperture that projects onto an area of the two-dimensional scatterer where the area has a lateral dimension equal to the square root of [symbol] times a, sqrt( [symbol] )*a, where a is the lateral dimension of each sub-aperture.

In FIG. 1B, AFN system 100 is shown during a scanning procedure. In this example, plane wave illumination 112 passes to SLM 130 and SLM 130 modulates the light according to phase pattern 131(a) determined from an optimization procedure such as may include the operation depicted in FIG. 1A. The adjustable pupil is actuated to open a full aperture 151(b). Light transmitted through global phase pattern 131(b) onto the adjustable pupil 150 with fully open aperture 151(b) is projected onto an area 190(e) on two-dimensional scatterer 103. A scaled version of the global phase pattern is projected onto area 190(e) of the two-dimensional scatterer 103 in area 190(e) through the implementation of 4f optical system 160. Light reflected from the two-dimensional scatterer 103 projects a focus spot at the plane of object 101. During a scanning procedure, the focal spot is scanned in the vicinity of the object 101 by imposing a spatial phase ramp on the global phase pattern 131(b). Alternatively digital mechanical micromirrors can be used to scan the focal spot. The reflected light from the object 101 scatters off the two-dimensional scatterer 103 and the light can be sampled by light detector 170. The image data sampled by light detector 170 can then be used to detect or image the object 101.

By simultaneously turning on all subsets of pixels (sub-apertures) of the adjustable pupil 150, and adjusting the phase relationships between the subsets by modulating the global phase pattern 131(b) as shown in FIG. 1B, a focus spot can be rendered. The rendered focus spot has a lateral dimension that is smaller than the lateral dimension of the original focus of a sub-aperture.

The AFN system 100 includes a computing system 180 in electrical communication with light detector 170 and with SLM 130 and/or adjustable pupil 150 to received data and to send control signals. In one aspect, the computing system 180 includes a data acquisition card (DAQ). The computing system 180 includes one or more processors or other circuitry and an internal non-transitory computer readable media (CRM) in electrical communication with the processor(s) or other circuitry. The processor(s) or other circuitry, additionally or alternatively, other external processor(s), can execute instructions stored on memory such as the internal non-transitory CRM to perform operations of the AFN system 100. For example, the processor(s) or other circuitry may execute instructions to perform operations of an AFN method. Some examples of operations that may be perform include, for example, (a) an optimization procedure to determine a global phase pattern, (b) rendering of final focal spot using global phase pattern, (c) actuating one or more components of the AFN system 100, and (d) scanning rendered focal spot over a vicinity of the obstructed object. In addition or alternatively, the processor(s) or other circuitry may send control signals to cause, for example, one or more of (i) actuation of light source 110, (ii) actuation of SLM 130, (iii) actuation of adjustable pupil 150, and (v) actuation of light detector 170 to take sample readings while one or more sub-apertures is open.

According to certain implementations, an AFN system may include a light source for providing illumination to the SLM. Alternatively, the light source or light sources may be a separate component. In one aspect, the AFN system includes at least one light source that is a laser such a continuous wave laser or a pulse laser. An example a suitable commercially-available laser that can be implemented is the DJ532-40 continuous-wave laser diode made by Thorlabs Inc. of Newton, N.J.

According to certain implementations, an AFN system includes a spatial light modulator configured, or configurable, to modulate a wavefront to generate a shaped wavefront. In some cases, the shaped wavefront may compensate for phase modulation of a two-dimensional scatterer. In certain cases, the spatial modulator may display one or more patterns of SLM pixels. Although certain examples of AFN systems are described herein in transmission mode with light transmitted through the SLM, in other implementations, the SLM may be in reflection mode. For example, the AFN system 100 in FIGS. 1A and 1B may alternatively actuate SLM 130 in reflection mode and include optical elements to pass the reflected light to adjustable pupil 350.

According to certain implementations, an AFN system includes an adjustable aperture configured, or configurable, to open one or more sub-apertures of the full aperture used in the AFN method and/or open the full aperture. In one aspect, the full aperture used in an AFN method is the largest aperture of the adjustable aperture. In other cases, the full aperture used in the AFN method is smaller than the largest aperture of the adjustable aperture. In one aspect, the adjustable aperture is a digital micro-mirror device (DMD). An example a suitable commercially-available DMD that can be implemented is the DLP® Lightcrafter™ 6500 Evaluation module made by Texas Instruments.

Although certain examples of an AFN system described herein include an adjustable pupil, in another aspect, the adjustable pupil may be omitted. For example, an AFN system may include a high speed SLM that can provide one or more phase patterns at a high speed and an adjustable pupil may be omitted.

According to certain implementations, an AFN system includes a light detector configured, or configurable, to sample (record) a two-dimensional intensity distribution. In one aspect, the light detector is a photomultiplier tube (PMT). An example a suitable commercially-available light detector that can be implemented is photomultiplier tube (PMT) H9306-03 made by Hamamatsu.

According to certain implementations, an AFN system includes at least one data acquisition card (DAQ). The DAQ(s) can process signals from the light detector of the AFN system, for example, to digitize the signals and/or record the signals. An example a suitable commercially-available data acquisition card that can be implemented is PCI-MIO-16XE-10 DAQ made by National Instrument.

In some implementations, an AFN system includes a computing system configured or configurable (e.g., by a user) to: (i) output raw data, processed data such as image data, and/or other data over a communication interface to a display, (ii) output raw image data as well as processed image data and other processed data over a communication interface to an external computing device or system, (iii) output raw image data as well as processed image data and other data over a communication interface for storage in an external memory device or system, and/or (iv) output raw image data as well as processed image data over a network communication interface for communication over an external network (for example, a wired or wireless network). Indeed in some implementations, one or more of operations of an AFN method can be performed by an external computing device. The computing system may also include a network communication interface that can be used to receive information such as software or firmware updates or other data for download by the computing device. In some implementations, an AFN system further includes one or more other interfaces such as, for example, various Universal Serial Bus (USB) interfaces or other communication interfaces. Such additional interfaces can be used, for example, to connect various peripherals and input/output (I/O) devices such as a wired keyboard or mouse or to connect a dongle for use in wirelessly connecting various wireless-enabled peripherals. Such additional interfaces also can include serial interfaces such as, for example, an interface to connect to a ribbon cable. It should also be appreciated that one or more of components of the AFN system can be electrically coupled to communicate with the computing device over one or more of a variety of suitable interfaces and cables such as, for example, USB interfaces and cables, ribbon cables, Ethernet cables, among other suitable interfaces and cables.

The described electrical communication between components of AFN systems may be able to provide power and/or communicate data. The electrical communication between components of the AFN systems described herein may be in wired form and/or wireless form.

According to certain implementations, the computing system of an AFN system can perform parallel image processing. To perform parallel image processing, the computing device generally includes at least one processor (or “processing unit”). Examples of processors include, for example, one or more of a general purpose processor (CPU), an application-specific integrated circuit, an programmable logic device (PLD) such as a field-programmable gate array (FPGA), or a System-on-Chip (SoC) that includes one or more of a CPU, application-specific integrated circuit, PLD as well as a memory and various interfaces.

The computing system of an AFN system may be in communication with internal memory device and/or an external memory device. The internal memory device can include a non-volatile memory array for storing processor-executable code (or “instructions”) that is retrieved by one or more processors to perform various functions or operations described herein for carrying out various logic or other operations on the image data. The internal memory device also can store raw image data, processed image data, and/or other data. In some implementations, the internal memory device or a separate memory device can additionally or alternatively include a volatile memory array for temporarily storing code to be executed as well as image data to be processed, stored, or displayed. In some implementations, the computing system itself can include volatile and in some instances also non-volatile memory.

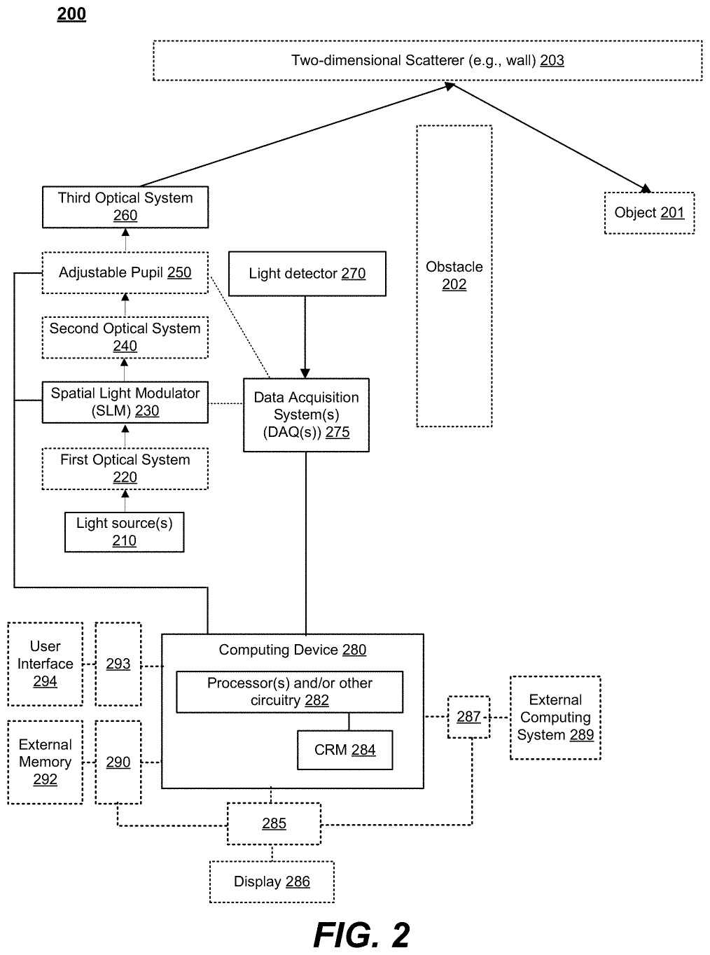

FIG. 2 is a simplified block diagram of components of an AFN system 200 for focusing light around or over an obstacle 102 to an object 101, according to an implementation. The illustrated example is shown at in instant during operation where object 101, obstacle 202, and a two-dimensional scatterer 203 are present. It would be understood that object 101, obstacle 202, and two-dimensional scatterer 203 may not be present (denoted by dashed lines around these block elements) when the AFN system 200 is not in operation.

AFN system 200 includes at least one light source 210, an optional (denoted by dashed line) first optical system 220, a spatial light modulator 230, an optional (denoted by dashed line) second optical system 240, an optional (denoted by dashed line) adjustable pupil 250, and a third optical system 260. In one aspect, the at least one light source 210 may be a laser such as a continuous wave laser or a pulse laser. The at least one light source 210 is configured to provide an illumination beam. Alternatively, the at least one light source 210 may be a separate component from AFN system 200.

The optional (denoted by dashed line) first optical system 220 is in communication with the at least one light source 210 and the SLM 230 to collimate and expand the illumination beam from the at least one light source 210 and provide plane wave illumination over at least a substantial portion of the SLM 230. The SLM 230 is configured, or configurable, to modulate the light to generate a shaped wavefront.

The optional second optical system 230 is in communication with the spatial light modulator 230 and the optional adjustable pupil 250 to pass modulated light from the spatial light modulator 230 to the adjustable pupil 230. The optional adjustable pupil 250 is configured, or configurable, to open one or more sub-apertures. The third optical system 260 is a 4f optical system configured such that the combined SLM 230 and adjustable pupil 250 and the two-dimensional scatterer 203 are an image-forming conjugate plane set. In this way, a scaled version of a phase pattern displayed on SLM 230 will be projected onto two-dimensional scatterer 203. As depicted by the arrows from third optical system 260 to two-dimensional scatterer 203 and to object 201, light is reflected off two-dimensional scatterer 202 to object 201.

AFN system 200 also includes a light detector 270, at least one data acquisition system (DAQ) 275, and a computing device 280. The light detector 270 is configured, or configurable, to sample photons scattered by the two-dimensional scatterer 203. The at least one data acquisition system (DAQ) 275 is in communication with the light detector 270 to receive signals with digitized light data from sampling photons scattered by the two-dimensional scatterer 203. Optionally, at least one data acquisition system (DAQ) 275 is also in communication with optional adjustable pupil 250 and/or spatial light modulator 230 to receive data.

The AFN system 200 also includes a computing system 280 in communication with spatial light modulator 230 and/or optional adjustable pupil 250 to send control actuation signals. Computing system 280 includes one or more processors or other circuitry 282 and an internal non-transitory computer readable media (CRM) 284 in electrical communication with the processor(s) or other circuitry 282. The processor(s) or other circuitry 282, additionally or alternatively, other external processor(s), can execute instructions stored on memory such as internal non-transitory CRM 284 to perform operations of the AFN system 200. For example, the processor(s) or other circuitry 282 may execute instructions to perform operations of an AFN method such as one or more of (a) optimize phase patterns for the sub-apertures of the full-aperture, (b) determine phase offsets between sub-apertures in a full aperture, (c) render focal spot using global phase pattern, and (c) scan focal spot over a vicinity of the obstructed object. In addition or alternatively, the processor(s) or other circuitry may send control signals to cause, for example, one or more of (i) activation of at least one light source 210 (e.g., laser), (ii) activation of SLM 230, and (iii) activation of optional adjustable pupil 250 (iv).

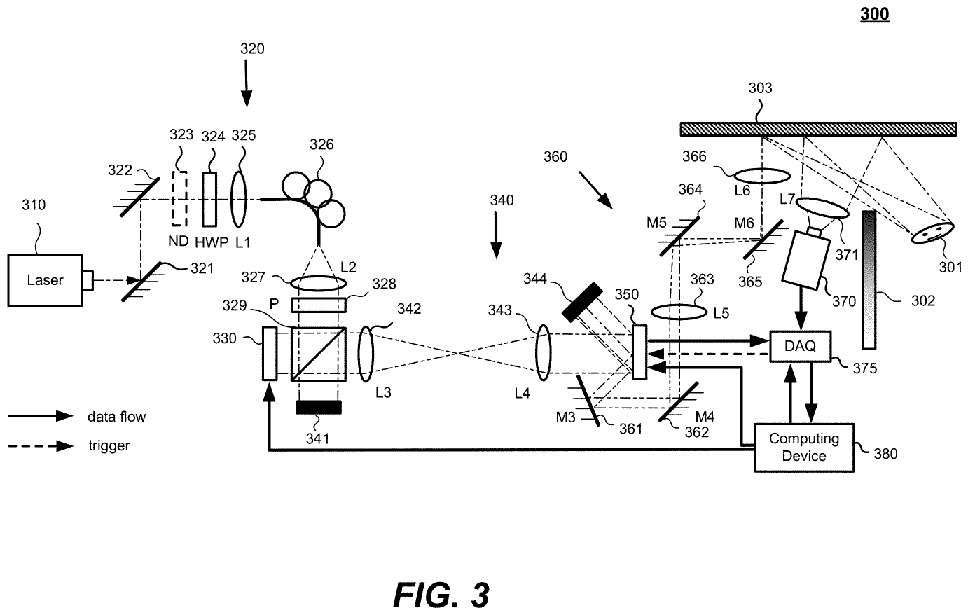

FIG. 3 is a schematic diagram of components of an AFN system 300 during operation, according to an implementation. As shown in the key, the thick solid lines between components denote sending signals with data (data flow) and thick dashed lines between components denote trigger signals.

The AFN system 300 includes a light source (or light sources) 310 such as, for example, a continuous wave laser or a pulsed laser. An example a suitable commercially-available laser that can be implemented is the DJ532-40 continuous-wave laser diode made by Thorlabs Inc. of Newton, N.J. The AFN system 300 also includes a first optical system 320, a spatial light modulator (SLM) 330, a second optical system 340, an adjustable pupil 350 (e.g., a digital micromirror device (DMD)), and a third optical system 360. The AFN system 300 is shown during a method of focusing light around/over an obstacle 302 to an object 301. During this operation, the reflection from the adjustable pupil 350 is projected to a scatterer 203 (e.g., a wall).

As shown, the light beam from the light source 310 passes to the spatial light modulator (SLM) 330 via a first optical system 320, which includes a first mirror 321, a second mirror 322, a half-wave plate 324, a first lens 325, a polarization maintaining fiber (PM fiber) 326 for spatial filtering, a second lens 327, a polarizer 328, and a beam splitter 329. The light source 310 passes through first mirror 321 and second mirror 322 and half-wave plate 324 and is coupled into polarization maintaining fiber 326 for spatial filtering. Half-wave plate 324 can be used to align the polarization of the beam to the fast axis of the PM fiber 326 and first and second mirrors 321, 322 can be used to couple the light into PM fiber 326. The filtered light exiting the PM fiber 326 is expanded by the second lens 327 to fully cover the active area of the SLM 330. Collimated light is provided to SLM 330 and SLM 330 can manipulate the wavefront the provide a shaped wavefront. An example of an SLM that can be used is the Pluto NIR II Spatial Light Modulator made by HOLOEYE Photonics AG of Berlin, Germany.

Second optical system 340 includes a first beam blocker 341, a first 4f system including a third lens 342 and a fourth lens 343, and a second beam blocker 344. The beam splitter 329 and the first 4f system including third lens 342 and fourth lens 343 image the wavefront shaped light reflected by SLM 330 onto adjustable pupil 350. The first 4f system images the SLM 330 onto the adjustable pupil 350. An example a suitable commercially-available DMD that can be implemented is the DLP® Lightcrafter™ 6500 Evaluation module made by Texas Instruments. The third lens may be used to match the different pixel sizes on SLM 330 and adjustable pupil 350. Adjustable pupil 350 is pixel-to-pixel conjugated to SLM 330 and used to sequentially open the sub-apertures during the optimization process and to open the full aperture to actively focus the final focal spot around/over the obstacle 302.

Third optical system 350 includes a third mirror 361, a fourth mirror 362, a second 4f system including a fifth lens 363 and a sixth lens 366, a fifth mirror 364, and a sixth mirror 366. Mirrors 361, 362, 364, 366 and the second 4f system project the reflection from adjustable pupil 350 onto scatterer 303. The second 4f system images the adjustable pupil 350 onto scatterer 330. The reflection from scatterer 303 impinges on object 302. The object 302 bounces photons back to the two-dimensional scatterer 303.

The AFN system 300 also includes a light detector 370 (e.g., a photomultiplier tube (PMT)), a seventh lens 371 (e.g., a condenser lens), a data acquisition card (DAQ) 375, and a computing device 380. An example a suitable commercially-available light detector that can be implemented is photomultiplier tube (PMT) H9306-03 made by Hamamatsu. The light detector 370 and the seventh lens 371 are used to collect light that returns from object 302 by way of diffuse reflection from scatterer 303. Signals with readings from light detector 370 may be received (denoted by thick solid arrows to DAQ 375) and recorded by DAQ 375. An example a suitable commercially-available data acquisition card that can be implemented is PCI-MIO-16XE-10 DAQ made by National Instrument.

The computing device 380 may have one or more processors or other circuitry and an internal non-transitory computer readable media (CRM) in electrical communication with the processor(s) or other circuitry. The processor(s) or other circuitry, additionally or alternatively, other external processor(s), can execute instructions stored on memory such as internal non-transitory CRM to perform operations of the AFN system 300. For example, the processor(s) or other circuitry may execute instructions to perform operations of an AFN method such as one or more of (a) optimize phase patterns for the sub-apertures of the full-aperture, (b) determine phase offsets between sub-apertures in a full aperture, (c) render focal spot using global phase pattern, and (c) scan focal spot over a vicinity of the obstructed object. In addition or alternatively, the processor(s) or other circuitry may send control signals to cause, for example, one or more of (i) activation of light source 310 (e.g., laser), (ii) activation of SLM 330, (iii) activation of adjustable pupil (iv), and (v) activation the light detector 370 to take intensity readings while one or more sub-apertures is open.

Optionally, signals with data from adjustable pupil 350 may be received (denoted by thick dashed arrows to DAQ 375) and recorded by DAQ 375 and trigger signals may be sent (denoted by thick dashed arrows from DAQ 375) to adjustable pupil 350. In one implementation, for example, signals recorded by the light detector 370 may be synchronized with opening of a sub-aperture by adjustable pupil 350 during an optimization procedure of an AFN method. In this example, trigger signals may be sent to the adjustable pupil 350 to turn on a particular sub-aperture as denoted by a dotted thick arrow line from DAQ 375 to adjustable pupil 350. The trigger signals to adjustable pupil 350 may be synchronized with the readings received from light detector 370. For example, a signal from light detector 370 (denoted as a solid thick arrow line between the light detector 370 and the DAQ 375) may be received at DAQ 37 indicating exposure for light data acquisition. In response, the DAQ 375 may send a trigger signal to adjustable pupil 350 to open a sub-aperture. In other implementations, other methods of synchronizing opening of a sub-aperture with light data acquisition may be used.

During an optimization procedure of an AFN method, adjustable pupil 350 is modulated to generate a number of sub-apertures, [symbol] , that are partitions of the full aperture and the SLM 330 is modulated to generate a number of phase patterns, N². During the optimization procedure, computing device 380 sends trigger signals to the SLM 330 (denoted by thick solid arrow line) to update the phase pattern being projected onto adjustable pupil 350 via the second optical system 340. After the optimization procedure is complete, an optional neural density filter 323 (denoted by dotted line as an optional component) may be inserted prior to the scanning procedure to prevent the light from saturating light detector 370.

### III. AFN Methods for Focusing Light Around/Over an Obstacle

In certain implementations, an AFN method determines an engineered wavefront that can be used to counter the random but deterministic phase distortion associated with reflection from the scatterer toward the object. Using the engineered wavefront with the full aperture open, the reflection off the scatterer may be used to render a tight and scannable optical focus at the object where the size of the focal spot may be substantially smaller than the object itself. From optical geometry, the focus spot size may be related to the subtended illumination aperture at the two-dimensional scatterer. Since the AFN system includes a 4f system such that the input pupil and the scatterer are image-forming conjugate planes, the focal spot size can be controlled by controlling the input pupil size. The relationship between the full aperture size (fully opened pupil at the adjustable pupil) at the scatterer and the focal spot size (characterized by its full width at half maximum, FWHM) is λd/s, where s is the lateral size of the full aperture, λ is the wavelength of light, and d is the distance from the scatterer to the object. By superposing a suitable spatial phase ramp on the optimized global SLM phase pattern or by using mechanical means such as mechanical mirrors, the focal spot can be scanned across the object and its surroundings.

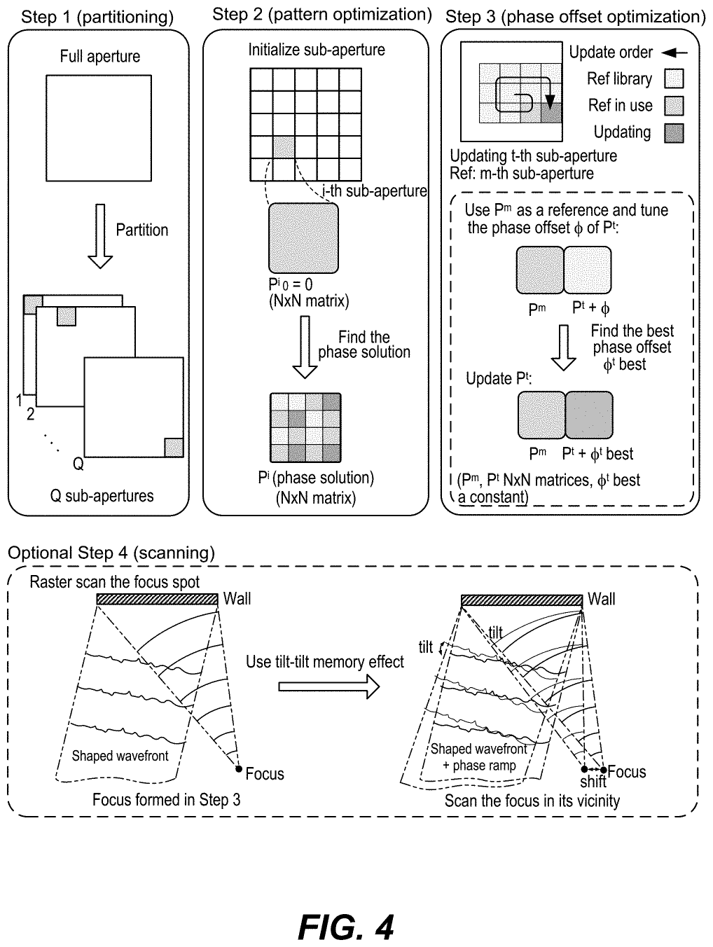

FIG. 4 is a schematic diagram depicting steps of an AFN method, according to an implementation. The AFN method includes a three-step process for determining the optimized global phase pattern for a full aperture and an optional fourth scanning step for scanning the final focal spot across the vicinity of the object.

At step 1, the full aperture is partitioned into Q sub-apertures. At this step, the size of the sub-apertures and the number of the sub-apertures may be determined. In certain cases, the speckle size (final focal spot size) is set to, or approximately to, the size of the object. In one example, the size of the sub-apertures is selected so that the two adjacent sub-apertures render a diffraction-limited focal spot at the object that is larger than the object's size. For example, the sub-aperture size may be smaller than λd/t, where t is the lateral size of the object.

The number of sub-apertures used to partition the full aperture may be determined based on a desired image resolution. The size of the final focus spot with the full-aperture open is inversely proportional to the square root of the number of sub-apertures. For example, for a resolution of a final focus spot size of 10× smaller than an object being imaged where the intermediate focus size of one optimized sub-aperture is comparable to the size of the object, 100 sub-apertures is used.

At step 2, a pattern optimization procedure is performed. At this step, a phase pattern solution for each sub-aperture is optimized by determining a phase pattern modulated by the SLM that generates a maximum reading of reflected light from the light detector. During this operation, the adjustable pupil is used to sequentially open different sub-apertures (a small pupil at different locations) of a full aperture (full pupil). The adjustable pupil generates a sub-aperture at a plurality of different locations (i-th sub-aperture where i=1 to Q). At each sub-aperture location, the SLM displays different phase patterns, and the light detector takes readings of light scattered by the two-dimensional scatterer. For each sub-aperture location, an optimized phase pattern is determined that generates a maximum light intensity reading from the light detector.

At step 3, a phase offset optimization procedure is performed to determine the correct phase relationship between the sub-apertures to be able synthesize the full aperture. At this step, a first reference sub-aperture is selected and an adjacent sub-aperture is selected to form an initial sub-aperture pair. In one implementation, the sub-aperture at the center of the full aperture is selected as the initial reference sub-aperture.

In each sub-aperture pair, one of the patterns serves as a reference and a global phase offset of the other pattern is tuned to maximize the feedback signal from the object. When the global phase offset that maximizes the feedback signal is determined, the global phase offset is added to the optimized phase pattern being updated to generate an updated pattern. For example, a constant global phase offset may be added to each SLM pixel of the phase pattern. The process is then repeated with the updated sub-aperture acting as new reference and selecting a new adjacent sub-aperture to update. In one aspect, the sub-apertures are selected in a spiral sequence such as, for example, shown in FIG. 4. The updated patterns are combined to form a global phase pattern. The final focus spot is rendered by displaying the global optimized phase pattern on the SLM and actuating the adjustable pupil for full aperture transmission.

At optional (denoted by dashed line) step 4, the final focus spot is scanned in the vicinity of the object. In one aspect, the final focal spot is scanned in the vicinity of the object (e.g., across the object) by imposing a spatial phase ramp on the SLM wavefront solution to raster scan the focal spot across the object. The scan range can be determined by the tilt-tilt memory effect. In another aspect, mechanical mirrors can mechanically shift the shaped wavefront. In one implementation, the final focus spot may be scanned over the object while the light detector captures light data scattered by the scatterer and the light data is used to image the object.

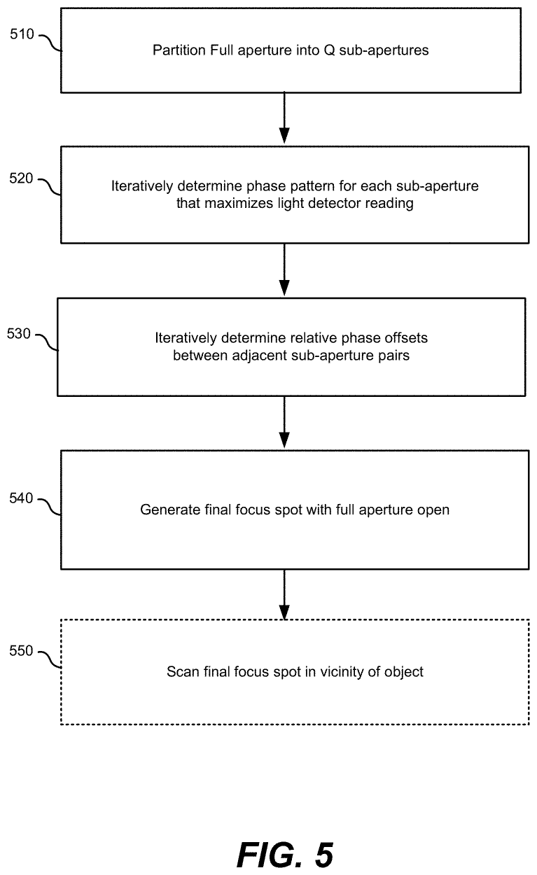

FIG. 5 is a flowchart of an example of an AFN method used by an AFN system, according to an implementation. At operation 510, the full aperture is partitioned into Q sub-apertures based on sub-aperture size and number of sub-apertures. In one aspect, the size of the sub-apertures and the number of the sub-apertures may be determined based on a desired resolution of the focal spot. The size of the final focus spot with the full-aperture open is inversely proportional to the square root of the number of sub-apertures. For example, for a resolution of a final focus spot size of 10× smaller than an object being imaged where the intermediate focus size of one optimized sub-aperture is comparable to the size of the object, 100 sub-apertures is used.

The AFN system includes a 4f optical system that images a scaled version of the SLM pixels of the sub-aperture onto the two-dimensional scatterer during operation. The reflected light from the two-dimensional scatterer can project a speckle field at the plane of the object with a speckle size nominally given by λd/a, where λ is the wavelength of light, a is the lateral size of the sub-aperture, and d is the distance between the two-dimensional scatterer and the object. Similarly, the relationship between the full aperture size (fully opened pupil) at the two-dimensional scatterer and the focal spot size (characterized by its full width at half maximum, FWHM) is λd/s, where s is the lateral size of the full aperture, λ is the wavelength of light, and d is the distance from the two-dimensional scatterer to the object. A sub-aperture size can be calculated for a particular resolution of the focal spot size based on this relationship. For example, if the distance between the scatterer and the object is 10 m and the object size is 10 mm and using 500 nm light as the light source, the lateral dimension of the sub-aperture size should be set to about 500 μm in order to have a speckle size that is similar to the size of the object.

In one aspect, the size of the final focal spot on the object and associated resolution may be controlled by adjusting the size of the light projection sub-aperture on the two-dimensional scatterer and the number of sub-apertures used to partition the full aperture. In one implementation, a user-defined resolution may be used to determine the number of sub-apertures and sub-aperture size. In this example, the computing device received user input with a user-defined image resolution. The number of sub-apertures may be determined based on the size of the object being imaged and the user-defined image resolution.

Returning to FIG. 5, at operation 520, the AFN method performs a pattern optimization procedure. In this operation, a phase pattern solution (phase modulation) for each sub-aperture is optimized by determining a phase pattern modulated by the SLM that generates a maximum reading of reflected light from the light detector. During this operation, the adjustable pupil is used to sequentially open different sub-apertures (a small pupil at different locations) of a full aperture (full pupil). The adjustable pupil generates a sub-aperture at a plurality of different locations (i-th sub-aperture where i=1 to Q). At each sub-aperture location, the SLM displays different phase patterns, and the light detector takes readings of light scattered by the two-dimensional scatterer. For each sub-aperture location, an optimized phase pattern is determined that generates a maximum light intensity reading from the light detector.

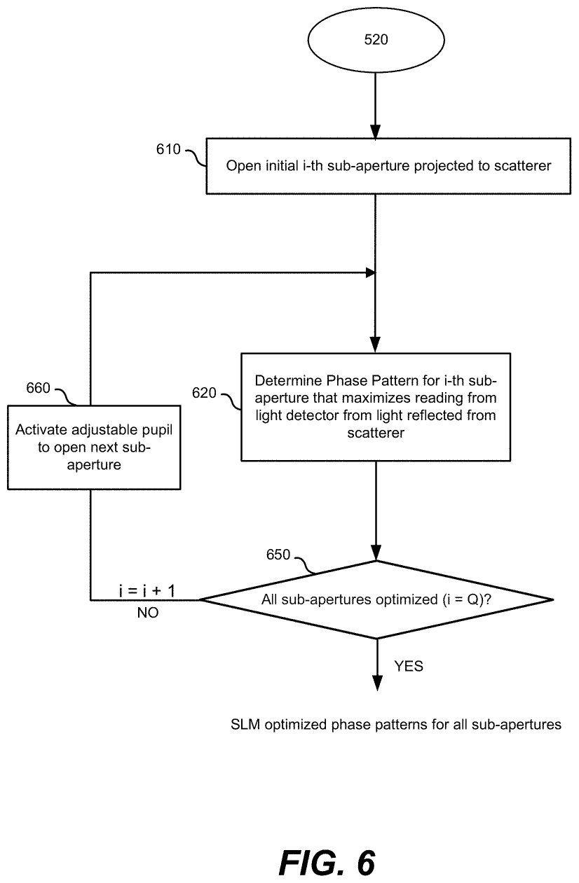

FIG. 6 illustrates a flowchart of an example of sub-operations of operation 520, according to an implementation. At sub-operation 610, the i-th sub-aperture is initialized (i=1) and projected to the two-dimensional scatterer. The adjustable pupil is triggered to open the sub-aperture at an initial location and the sub-aperture is projected to the two-dimensional scatterer. Light reflected from the two-dimensional scatterer is projected at the plane of the object. Light bouncing off the illuminated object and scattered by the two-dimensional scatterer (e.g., wall) is measured by the light detector.

At sub-operation 620, an optimized phase pattern for the i-th sub-aperture is determined that maximizes the readings from the light detector. In one aspect, the optimized phase pattern may be determined using a feedback-based technique.

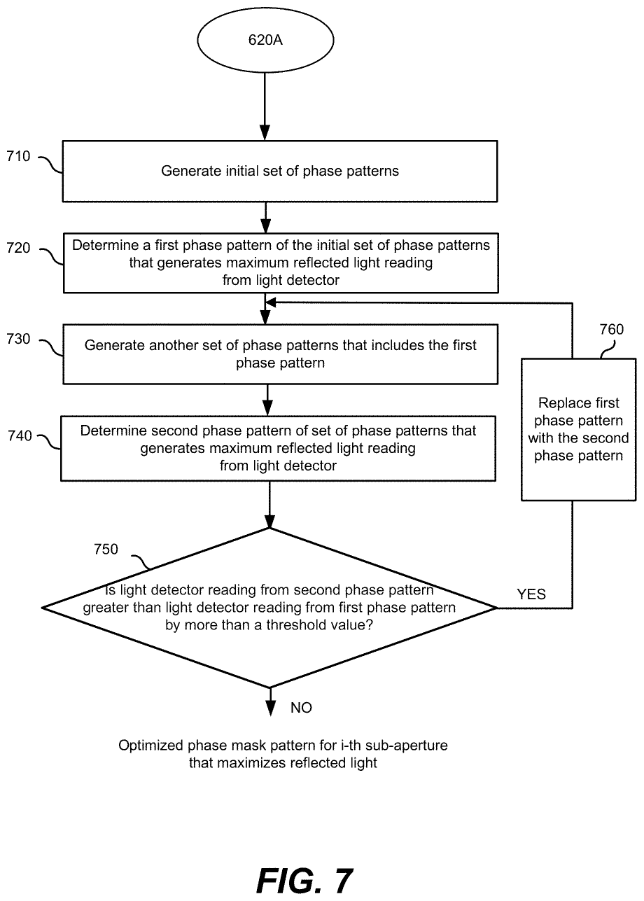

FIG. 7 is a flowchart of an example of sub-operations of sub-operation 620 that uses a feedback-based technique, according to an implementation. At sub-operation 710, the method actuates the SLM to modulate different sets of pixels to generate an initial (first) set of phase patterns. For example, the SLM may modulate phase of light according to a brightness of a grayscale image. Each of the SLM patterns from the initial set of phase patterns is projected to the two-dimensional scatterer. Light reflected from the two-dimensional scatterer is projected at the plane of the object. Light bouncing off the illuminated object and scattered by the two-dimensional scatterer (e.g., wall) is measured by the light detector. The light detector takes a reading for each phase pattern of the first set of phase patterns imaged onto the two-dimensional scatterer.

At sub-operation 720, the method selects a first phase pattern of the first set of phase patterns that generates a maximum reading (e.g., maximum intensity reading) from the light detector. At sub-operation 730, the SLM is actuated to modulate different sets of SLM pixels that adds the first set of phase patterns to the first phase pattern determined in sub-operation 720 to generate another (second) set of phase patterns that includes the first phase pattern. Each of the SLM patterns from the second set of phase patterns is projected to the two-dimensional scatterer and the light detector takes a reading for each phase pattern of the second set of phase patterns imaged onto the two-dimensional scatterer. At sub-operation 740, the method selects a second phase pattern of the second set of phase patterns that generates a maximum reading from the light detector.

At sub-operation 750, the method determines whether the light reading from the second phase pattern is greater than the light reading from the first phase pattern by more than a threshold value (e.g., a percentage). If the light reading from the second phase pattern is greater than the light reading from the first phase pattern by more than the threshold value, the method replaces the first phase pattern with the second phase pattern and returns to sub-operation 730 to modulate another set of SLM pixels to generate another set of phase patterns. If the light reading from the second phase pattern is less than, or equal to, the light reading from the first phase pattern by more than a threshold value, the method returns the first phase pattern as an optimized phase pattern for the i-th sub-aperture to sub-operation 650 in FIG. 6.

Returning to FIG. 6, at sub-operation 650, the method determines whether all Q sub-apertures of the full aperture have been optimized. If all sub-apertures have not been optimized, the sub-aperture index is incremented (i=i+1) and the next sub-aperture is opened at the next location (sub-operation 660). If all sub-apertures have been optimized, the optimized SLM phase patterns for all sub-apertures have been determined and the method returns to operation 530.

Returning to FIG. 5, at operation 530, the AFN method performs a phase offset optimization procedure to determine the correct phase relationship between the sub-aperture macro-modes to synthesize the full aperture. In this operation, a phase offset for each sub-aperture pair of a plurality of sub-aperture pairs of the full aperture is determined that maximizes the feedback signal from the object. In each sub-aperture pair, one of the patterns serves as a reference and the global phase of the other pattern is tuned to maximize the return feedback signal.

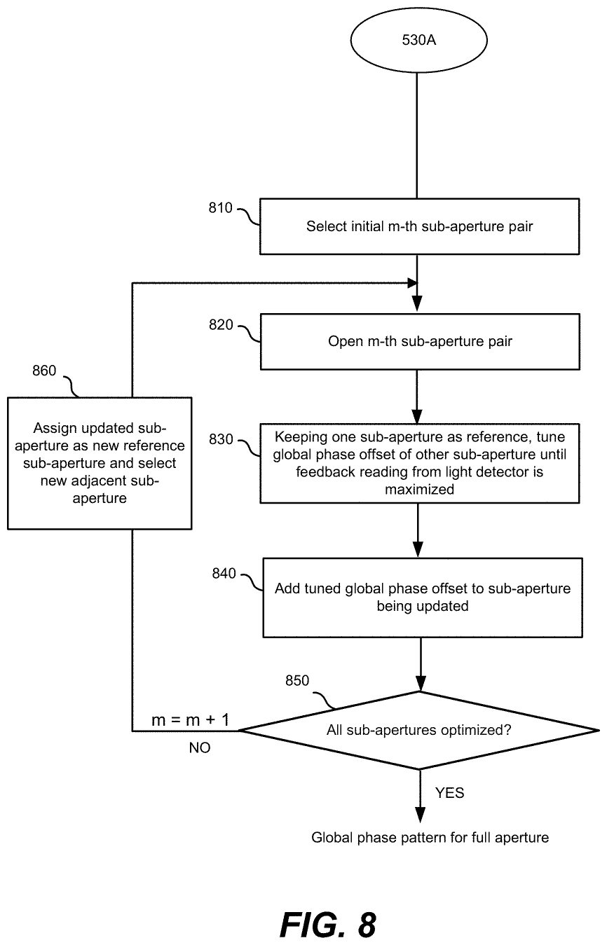

FIG. 8 depicts a flowchart of an example of sub-operations of sub-operation 530, according to an implementation. At sub-operation 810, a first reference sub-aperture is selected. In one implementation, the sub-aperture at the center of the full aperture is selected as the reference sub-aperture. An adjacent sub-aperture is selected to form an initial m-th sub-aperture pair. In one aspect, the sub-apertures are selected in a spiral sequence as shown, for example, in FIG. 4. At sub-operation 820, the adjustable pupil is triggered to open sub-apertures of the initial m-th sub-aperture pair and the SLM is triggered to display the corresponding optimized phase patterns determined in a pattern optimization procedure such as, e.g., the procedure shown in FIGS. 6 and 7.

In each sub-aperture pair, one of the patterns serves as a reference and a global phase offset of the other pattern is tuned (adjusted) to maximize the feedback signal from the object. At sub-operation 830, the global phase offset of the sub-aperture being updated is tuned to maximize the feedback signal from the object. For example, a range of global offset values may be imposed on the SLM display pixels of the pattern being updated to determine the maximum feedback signal on the light detector.

At sub-operation 840, once the global phase offset that maximizes the feedback signal is determined, the global phase offset is added to the phase pattern being updated to generate an updated pattern. For example, the global phase offset may be added to each SLM pixel of the phase pattern being updated. At sub-operation 850, the method determines whether global phase offsets of all sub-apertures have been tuned. If not, the updated sub-aperture acts as the new reference and a new adjacent sub-aperture is selected to form a new m-th sub-aperture pair with the index incremented (m=m+1) (sub-operation 860). In one aspect, the new sub-apertures are selected in a spiral sequence such as, for example, shown in FIG. 4. The process is then repeated for the new m-th sub-aperture pair by returning to sub-operation 820. If it is determined at sub-operation 850 that the global phase offsets for all the sub-apertures have been tuned, the patterns from the process are combined to form a global phase pattern and the method returns to operation 540 shown in FIG. 5.

Returning to FIG. 5, at operation 540, the final focus spot on the object is rendered by displaying the global phase pattern on the SLM and actuating the adjustable pupil for full aperture transmission. At optional (denoted by dashed line) operation 550, the final focus spot is scanned in the vicinity of the object (e.g., across the object). In one aspect, the final focal spot is scanned by imposing a spatial phase ramp on the global SLM pattern to raster scan the focal spot across the object. In another aspect, mechanical mirrors can mechanically shift the shaped wavefront.

In one implementation, the final focus spot may be scanned over the object while the light detector captures time-varying light data. The computing system receives signals from the light detector with the time-varying light data. The computing system may combine the time varying light data to generate a two-dimensional image of the object and/or an area in the vicinity of the object. In one implementation, the focus is scanned using a fixed step size, which corresponds to the pixel size in the formed image. The brightness of each pixel on that image equals to the signal the light detector captures at the corresponding position.

Certain aspects may provide one or more technical advantages. For example, one technical advantage may be that an AFN method or system does not require modulation of light directly on the object. The output from a spatial light modulator is directly imaged onto the two-dimensional scattering object using an optical system and light bouncing off the object and scattered by the two-dimensional scattering object is captured by a light detector. Further, AFN methods and system may generate a scannable focus spot at an obstructed object using random scattering off a standard wall. Such focusing may offer advantages when used for non-line-of-sight imaging. One technical advantage of an AFN method of an implementation may be the ability to image an obstructed view object at resolution that can be adjusted from coarse to fine e.g. down to micrometers. The AFN focusing method can flexibly create optical focus over a broad range of length scale. This advantage is an improvement over other NLOS imaging systems that have a lateral resolution determined by the temporal bandwidth of the time-of-flight camera, which may be no better than the scale of millimeters. Another technical advantage of an AFN method or system of an implementation may be the ability to image a weaker object in the presence of a more strongly reflective object. Since AFN techniques may generate a focused light spot at the object itself and the focus spot can be freely scanned over a dynamic range, AFN focusing provides the ability to probe and image weaker objects in the vicinity of bright objects. This advantage is an improvement over other NLOS systems where the viewing dynamic range is more restricted due to reconstruction artifacts. Another technical advantage may be that the AFN focusing methods of certain implementations may provide a means to generate a focus spot on an object that can be several orders of magnitude higher in intensity than the surrounding depending on the number of modes. In one implementation, the focus spot can be used to perform high intensity spectroscopy probing of the target. Another technical advantage of an AFN method or system of an implementation may be the ability to focus light on the object, which in turn can be used to boost the return reflection signals from the object. For the same measurement conditions, this improved signal return can be parlayed into the ability to image more distant objects. This improvement in imaging range is expected to be at least 1-2 orders of magnitude better than other NLOS methods. Another technical advantage of an AFN method or system of an implementation may be the ability to deliver high optical power to the object for heating, power transfer or ablation purposes.

Modifications, additions, or omissions may be made to any of the above-described embodiments without departing from the scope of the disclosure. Any of the embodiments described above may include more, fewer, or other features without departing from the scope of the disclosure. Additionally, the steps of described features may be performed in any suitable order without departing from the scope of the disclosure. Also, one or more features from any embodiment may be combined with one or more features of any other embodiment without departing from the scope of the disclosure. The components of any embodiment may be integrated or separated according to particular needs without departing from the scope of the disclosure.

It should be understood that certain aspects described above can be implemented in the form of logic using computer software in a modular or integrated manner. Based on the disclosure and teachings provided herein, a person of ordinary skill in the art will know and appreciate other ways and/or methods to implement the present invention using hardware and a combination of hardware and software.

Any of the software components or functions described in this application, may be implemented as software code using any suitable computer language and/or computational software such as, for example, Java, C, C #, C++ or Python, LabVIEW, Mathematica, or other suitable language/computational software, including low level code, including code written for field programmable gate arrays, for example in VHDL. The code may include software libraries for functions like data acquisition and control, motion control, image acquisition and display, etc. Some or all of the code may also run on a personal computer, single board computer, embedded controller, microcontroller, digital signal processor, field programmable gate array and/or any combination thereof or any similar computation device and/or logic device(s). The software code may be stored as a series of instructions, or commands on a CRM such as a random access memory (RAM), a read only memory (ROM), a magnetic medium such as a hard-drive or a floppy disk, or an optical medium such as a CD-ROM, or solid stage storage such as a solid state hard drive or removable flash memory device or any suitable storage device. Any such CRM may reside on or within a single computational apparatus, and may be present on or within different computational apparatuses within a system or network. Although the foregoing disclosed embodiments have been described in some detail to facilitate understanding, the described embodiments are to be considered illustrative and not limiting. It will be apparent to one of ordinary skill in the art that certain changes and modifications can be practiced within the scope of the appended claims.

The terms “comprise,” “have” and “include” are open-ended linking verbs. Any forms or tenses of one or more of these verbs, such as “comprises,” “comprising,” “has,” “having,” “includes” and “including,” are also open-ended. For example, any method that “comprises,” “has” or “includes” one or more steps is not limited to possessing only those one or more steps and can also cover other unlisted steps. Similarly, any composition or device that “comprises,” “has” or “includes” one or more features is not limited to possessing only those one or more features and can cover other unlisted features.

All methods described herein can be performed in any suitable order unless otherwise indicated herein or otherwise clearly contradicted by context. The use of any and all examples, or exemplary language (e.g. “such as”) provided with respect to certain embodiments herein is intended merely to better illuminate the present disclosure and does not pose a limitation on the scope of the present disclosure otherwise claimed. No language in the specification should be construed as indicating any non-claimed element essential to the practice of the present disclosure.

Groupings of alternative elements or embodiments of the present disclosure disclosed herein are not to be construed as limitations. Each group member can be referred to and claimed individually or in any combination with other members of the group or other elements found herein. One or more members of a group can be included in, or deleted from, a group for reasons of convenience or patentability. When any such inclusion or deletion occurs, the specification is herein deemed to contain the group as modified thus fulfilling the written description of all Markush groups used in the appended claims.

What is claimed is:

1. An active focusing non-line-of-sight method, the method comprising:
focusing light over or around an obstacle to an object, the light focused using wavefront shaping based on readings of light scattered by a two-dimensional scatterer.

2. The active focusing non-line-of-sight imaging method of claim 1, wherein light transmitted through, or reflected from, a spatial light modulator is reflected from the two-dimensional scatterer to illuminate at least a portion of the object.

3. The active focusing non-line-of-sight imaging method of claim 1, wherein the focused light is configured to deliver focused energy for localized excitation and/or heating to the object.

4. The active focusing non-line-of-sight imaging method of claim 1, further comprising imaging the object by scanning a focal spot across a vicinity of the object, the focal spot based on the wavefront shaping.

5. The active focusing non-line-of-sight imaging method of claim 1, further comprising detecting or imaging the object using a focal spot generated based on the wavefront shaping.

6. The active focusing non-line-of-sight method of claim 5, wherein the focal spot is generated at least in part using (i) a global phase pattern for a full aperture projected to the two-dimensional scatterer and (ii) phase offsets between sub-apertures of the full aperture, wherein the global phase pattern and the phase offsets are determined to maximize readings of light scattered by the two-dimensional scatterer.

7. The active focusing non-line-of-sight method of claim 1, further comprising generating a focal spot using a global phase pattern and phase offsets determined at least in part by:
(I) iteratively determining a phase pattern for each sub-aperture projected to the two-dimensional scatterer that maximizes readings of light scattered by the two-dimensional scatterer; and/or
(II) iteratively determining a relative phase offset between adjacent sub-apertures of each sub-aperture pair of a plurality of sub-aperture pairs that maximizes readings of light scattered by the two-dimensional scatterer.

8. The active focusing non-line-of-sight method of claim 1, wherein wavefront shaping comprises:
determining a global phase pattern for a full aperture projected to the two-dimensional scatterer that maximizes readings of light scattered by the two-dimensional scatterer; and
determining phase offsets between adjacent sub-apertures of the full aperture that maximizes readings of light scattered by the two-dimensional scatterer.

9. The active focusing non-line-of-sight method of claim 8, further comprising generating a focal spot on the object at least in part by:
(a) loading sub-aperture pairs and phase offsets between the sub-aperture pairs into a spatial light modulator to project the global phase pattern to the two-dimensional scatterer; and
(b) activating an adjustable pupil to open the full aperture.

10. A non-transitory computer readable medium for active focusing non-line-of-sight imaging, when read by one or more processors, operatively coupled to a light detector and a spatial light modulator, cause the one or more processors to execute one or more operations comprising:
focusing light over or around an obstacle to an object, the light focused using wavefront shaping based on light detector readings of light scattered by a two-dimensional scatterer.

11. The non-transitory computer readable medium of claim 10, wherein light transmitted through, or reflected from, the spatial light modulator is reflected from the two-dimensional scatterer to illuminate at least a portion of the object.

12. The non-transitory computer readable medium of claim 10, wherein the focused light is configured to deliver focused energy for localized excitation and/or heating to the object.

13. The non-transitory computer readable medium of claim 10, wherein the one or more operations further comprise imaging the object by scanning a focal spot across a vicinity of the object, the focal spot based on the wavefront shaping.

14. The non-transitory computer readable medium of claim 10, wherein the one or more operations further comprise detecting or imaging the object using a focal spot generated based on the wavefront shaping.

15. The non-transitory computer readable medium of claim 14, wherein the focal spot is generated at least in part using (i) a global phase pattern for a full aperture projected to the two-dimensional scatterer and (ii) phase offsets between sub-apertures of the full aperture, wherein the global phase pattern and the phase offsets are determined to maximize readings of light scattered by the two-dimensional scatterer.

16. The non-transitory computer readable medium of claim 10, wherein the one or more operations further comprise generating a focal spot using a global phase pattern and phase offsets determined at least in part by:
(I) iteratively determining a phase pattern for each sub-aperture projected to the two-dimensional scatterer that maximizes readings of light scattered by the two-dimensional scatterer; and/or
(II) iteratively determining a relative phase offset between adjacent sub-apertures of each sub-aperture pair of a plurality of sub-aperture pairs that maximizes readings of light scattered by the two-dimensional scatterer.

17. The non-transitory computer readable medium of claim 10, wherein the wherein the one or more operations comprise:
determining a global phase pattern for a full aperture projected to the two-dimensional scatterer that maximizes readings of light scattered by the two-dimensional scatterer; and
determining phase offsets between adjacent sub-apertures of the full aperture that maximizes readings of light scattered by the two-dimensional scatterer.

18. The non-transitory computer readable medium of claim 17, wherein the one or more operations further comprise generating a focal spot on the object at least in part by:
(a) loading sub-aperture pairs and phase offsets between the sub-aperture pairs into the spatial light modulator to project the global phase pattern to the two-dimensional scatterer; and
(b) activating an adjustable pupil to open the full aperture.

19. A system for focusing light over or around an obstacle to an object, the system comprising:
a spatial light modulator configured to generate one or more phase patterns;
one or more optical elements configured to image light transmitted through, or reflected from, the spatial light modulator to a two-dimensional scatterer, wherein light reflected from the two-dimensional scatterer illuminates at least a portion of an object; and
a light detector configured generate readings based at least in part on light scattered by the two-dimensional scatterer;
wherein the spatial light modulator is configured to modulate phase based on a global phase pattern and phase offsets between the sub-aperture pairs to generate a focal spot on the object, wherein the global phase pattern and phase offsets are determined to maximize readings from the light detector.

20. The system of claim 19, further comprising an adjustable pupil configured to generate one or more sub-apertures of a full aperture, wherein the spatial light modulator is configured to project the global phase pattern onto the adjustable pupil.

21. The system of claim 19, wherein the focal spot is configured to deliver localized excitation and/or heating to the object.

22. The system of claim 19, wherein the spatial light modulator is further configured with a phase ramp to scan the focal spot across a vicinity of the object for imaging or detecting the object.
